(19) United States
(12) Patent Application Publication
(10) Pub. No.: US 2017/0061098 A1
(43) Pub. Date: Mar. 2, 2017

(54) CENTRALIZED PROFESSIONAL PLATFORM

(71) Applicant: Nagaraj Setty Holalkere, Lexington, MA (US)

(72) Inventor: Nagaraj Setty Holalkere, Lexington, MA (US)

(21) Appl. No.: 15/244,028

(22) Filed: Aug. 23, 2016

Related U.S. Application Data
(60) Provisional application No. 62/209,029, filed on Aug. 24, 2015.

(51) Int. Cl. G06F 19/00; G06Q 30/02; H04L 29/08

(52) U.S. Cl. CPC G06F 19/3487; H04L 67/10; G06Q 30/0269; G06F 19/322; G06F 19/321

(57) ABSTRACT

A method and system for a centralized professional platform for interaction between patients and physicians is disclosed. The method and system includes a website arrangement containing at least one profile having a medical study containing at least one medical image and personally identifying material. The method and system further includes a computer server coupled to the website arrangement and programmed to (i) remove the personally identifying material from the medical study, creating a redacted medical study; (ii) storing the redacted medical study; (iii) authorizing a plurality of authorized individuals to access the redacted medical study; and (iv) facilitate discussion between the plurality of authorized individuals about the redacted medical study to form a first opinion of the redacted medical study. The computer server stores the first opinion of the authorized individuals.

### CROSS-REFERENCE TO RELATED APPLICATION

This patent document claims priority to earlier filed U.S. Provisional Patent Application No. 62/209,029, filed on Aug. 24, 2015, the entire contents of which are incorporated herein by reference.

### BACKGROUND OF THE INVENTION

This patent document relates to a platform that includes website, and/or a computer-based application, and/or a smart phone based application, that facilitates interaction between professionals. There is a need for a centralized platform that supports the needs of professionals to track their achievements and to interact with each other, with customers, and with licensing entities. In addition, current available tools are limited in encouraging online learning and teaching efforts using positive reinforcement via rewarding.

### SUMMARY OF THE INVENTION

Particularly, the instant invention relates to a centralized professional computer-based platform (with hosted information that is accessible through a user interface such as a website and/or a computer-based application) for professionals tailored specifically to a particular professional field based on requirements for that field.

The instant invention provides a method and a system for providing a website and/or a computer-based application and/or a smart phone based application, that interacts with a single platform that provides a centralized access platform for professionals to interact, maintain a professional portfolio, keep track of professional certifications, submit renewal requests for professional certifications, meet and interact with other professionals who share the same professional interests or recreational interests, and do perform other tasks. The platform also enables users to contribute and use the educational and research material, and track current news and trends of that profession. The platform also encourages online learning and teaching efforts using positive reinforcement via rewarding of behavior.

The primary goal of the present invention is to provide a single platform, including website and smartphone apps that allows professionals (“individuals,” “website users,” or “users”) to do a variety of tasks. One can discuss medical patient information in a HIPAA-compliant (Health Insurance Portability and Accountability Act-compliant) manner. The operation of the present invention is discussed primarily with respect to how the user interacts with the platform directly through the website, though a user could interact with the platform through a smartphone application or another user interface. The website aggregates documents, and allows users to build and maintain a professional portfolio with information that is easily accessible when they need to apply for re-certification or credentialing, allows a user to easily connect with fellow alumni, optimizes patient care protocols, and allows users to collaborate and connect both professionally and recreationally. The website also encourages positive behavior among users by providing reward points.

The website includes a portfolio builder, which allows users to list their achievements, import documents, and organize documents and certifications. This is useful for collecting certificates issued by third parties (such as the FDA (Food and Drug Administration) or medical licensing boards). This is also useful for organizing certificates and other documents that need to be provided to third parties for application for certification. Users are reminded of upcoming certification or re-certification deadlines. Documents can be uploaded or otherwise collected on the site, and, preferably, after a one-click step can then be directly exported to the institution that administers the certification process.

The website allows a user to list and link to professional publications. Publications from other sites (e.g. PubMed) can be imported into the user's profile. The site tracks how frequently a user publishes and in what journals a user is published, and notifies other users of recent publications or achievements. Other users can rate these achievements, and the site tracks these ratings. Ratings on individual events (e.g. publications, other achievements, etc.) can be used to provide an overall user rating. Thus, the site provides a peer ranking system.

The website facilitates user interaction through a messaging system. The website provides a HIPAA-compliant group chat. The group chat allows a user to share HIPAA-protected information between a select group of users. For example, this allows a doctor at a remote hospital to upload documents related to a patient (e.g. an imaging study), and allows the user to invite feedback from a select group of other doctors.

Actions of users are tracked, to show how the users are interacting with each other. Positive behavior is rewarded. All posts on the site can be rated. All posts can be reported to a site administrator/moderator.

The website provides alumni platforms for educational institutions, such as medical schools, medical residency programs, medical fellowship programs, etc. Users who attended these institutions are automatically added to a list of alumni on these alumni pages. The institutions can advertise events and connect with alumni directly through this alumni page.

Users can upload medical cases, which can be indexed. The cases can include teaching files for an institution. The teaching medical cases can be made public for educational purpose via editorial review process. The editors of the platform will review the published cases before it is made publically accessible. The editor may accept, reject or accept following additional edit based on the educational content. The authors and co-authors of the published cases can thus obtain authorship of publication and improve their personal profile. The platform provides collaborative online edit feature for authors and all the co-authors of a case where the content including medical images can be edited, for example, author A uploads a case as a draft case under his login profile and lists co-authors X and Y for the case. Then the co-authors X and Y will get notification and the case will be listed as a draft case under co-authors login X and Y. Co-authors X and Y can make changes to the case online and author A will submit the finalized case for publication. During this collaborative editing by contributors of a case the application allows only one author or co-author to edit at a time and locks the access to others. The last edit date and time by a contributor on a case will be displayed to all the contributors. The website also provides a platform for medical licensing board exam preparation. For example, the site includes database of multiple-choice questions (MCQs) and answers to prepare for the board exams.

Users can also upload cases that require a stat read or consultation when there is a rare or challenging case and get advice from experts on the system.

Presentations from medical conferences can be uploaded by users. These presentations are indexed. The presentations can include text documents, slides, videos, and audio files. The presentations can be conference presentations or instructional presentations or disease focused expert material. Teaching documents and files can be provided in addition to the instructional presentations. The platform can also support live online seminars (“webinars”) or conferences.

The platform enables users to discuss and refine industry practices. Users can discuss protocols used for procedures, share and develop templates for reporting findings, and share resources that are useful for teaching anatomy.

The platform also provides information to users related to continuing medical education, jobs, and medical equipment. The site provides pages for manufacturers and their products, allowing users to post reviews of medical equipment, products and manufacturers.

The platform allows users to more easily coordinate professional and recreational engagements. Users can advertise educational events (such as upcoming conferences or lunch meetings) as well as networking events or recreational events (such as a tennis group looking for partners). Researchers can more easily collaborate with other researchers, by advertising what resources they need and what resources they have that may be available to other researchers (e.g. animal studies that use different parts of the animals). Researchers can build concepts with other researchers. Users can see what topics are trending in research.

Some embodiments of the platforms include tools for patients or members of the public to interact with medical professionals. Some embodiments include a feature that allows a patient to request a second opinion, for example a second read of a CT (computed tomography) scan.

Accordingly, among the objects of the instant invention are: the provision of a method and a system that provide a single platform that allows an individual to maintain a professional online profile, interact with other individuals who share common interests, review professional certification requirements, renew professional certifications, share details regarding upcoming events, share documents, collaborate with other professionals, rate other professionals, and rate products used by professionals in the professional field; the provision of a centralized professional website that allows users to share HIPAA-protected medical images in a HIPAA-compliant manner; the provision of a centralized professional website that facilitates interaction between professionals in a geographic region; the provision of a centralized professional platform that facilitates interaction between graduates of a given educational institution; the provision of a centralized professional website that facilitates sharing of medical images between professionals for a second opinion; and a centralized professional website that facilitates sharing of medical images between patients and physicians.

Other objects, features and advantages of the invention shall become apparent as the description thereof proceeds when considered in connection with the accompanying illustrative drawings.

### DESCRIPTION OF THE DRAWINGS

In the drawings which illustrate the best mode presently contemplated of carrying out the present invention:

FIG. 1 is a block diagram of a system for supporting the operations of the centralized professional website for medical professionals and for interacting with devices of physicians and patients;

FIG. 2 is a flowchart according to a first aspect of the present invention;

FIG. 3 is a flowchart for creation of a data profile for an individual;

FIG. 4 is a flowchart for sharing medical studies that include personal information;

FIG. 5 is another flowchart for sharing of medical studies;

FIG. 6 is a general block diagram of an individual profile hosted on the server;

FIG. 7A shows a more detailed block diagram of a Basic Portfolio Builder of an individual profile hosted on the server;

FIG. 7B shows a more detailed block diagram of an Advanced Portfolio Builder of an individual profile hosted on the server;

FIG. 7C shows a more detailed block diagram of a Bibliography component of an individual profile hosted on the server;

FIG. 8 shows actions a user can take with a portfolio;

FIG. 9A shows a sample block diagram of the structure of alumni groups;

FIG. 9B shows enlarged viewed of inset 902 of FIG. 9A;

FIG. 9C shows an enlarged view of inset 904 of FIG. 9A;

FIG. 10A shows an overview of all of the features of an exemplary embodiment of the platform of the present invention;

FIGS. 10B-10F show enlarged portions of FIG. 10A; and

FIG. 11 shows a chart of a collaborated online editing feature of the system.

### DESCRIPTION OF THE PREFERRED EMBODIMENT

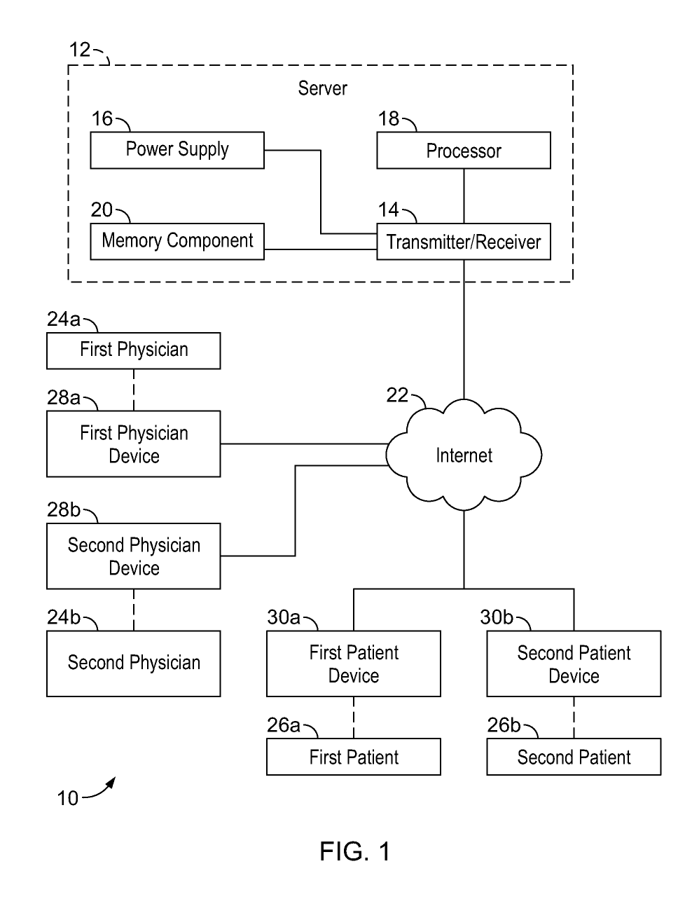

Referring now to the drawings, the centralized professional platform of the instant invention is illustrated and generally indicated in FIGS. 1-10F. As will hereinafter be more fully described, the instant invention provides a centralized professional website that provides an integrated platform for a wide variety of professional needs. The centralized professional website provides a single website that an individual can use to share documents, track professional and educational experience, and track achievements throughout his or her career. A user of the centralized professional website can use the website to interact with clients, customers, colleagues, licensing bodies, educational institutions, professional institutions, employers, and others.

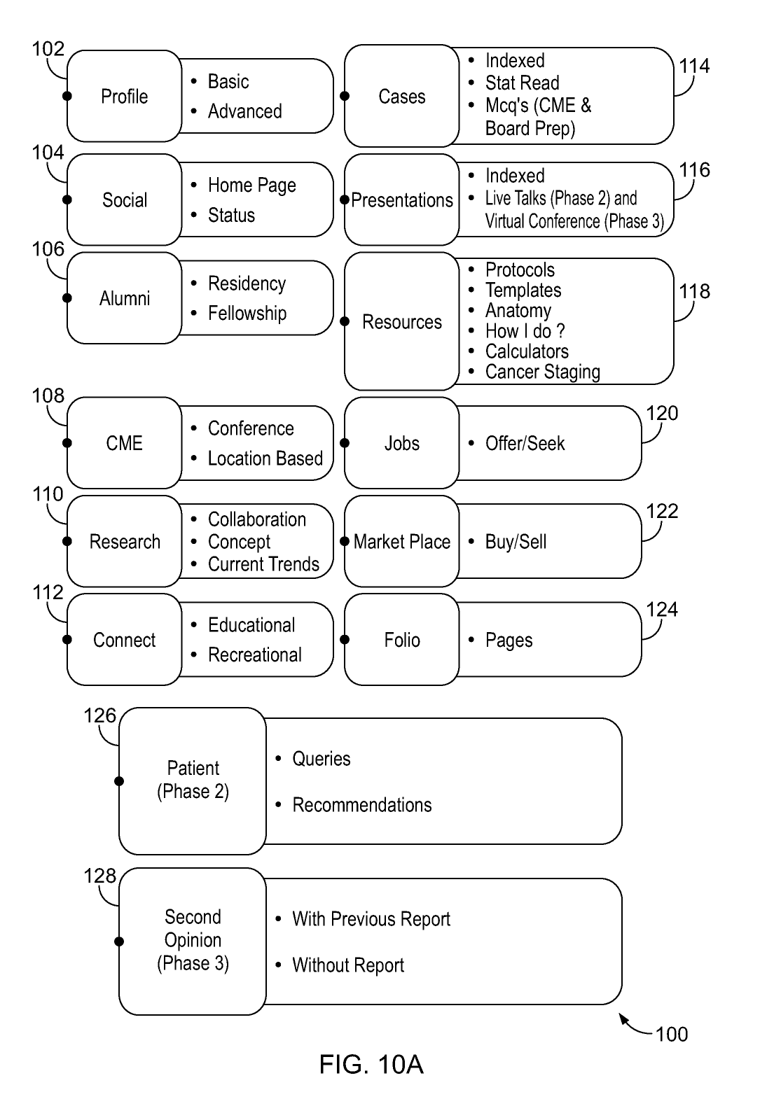

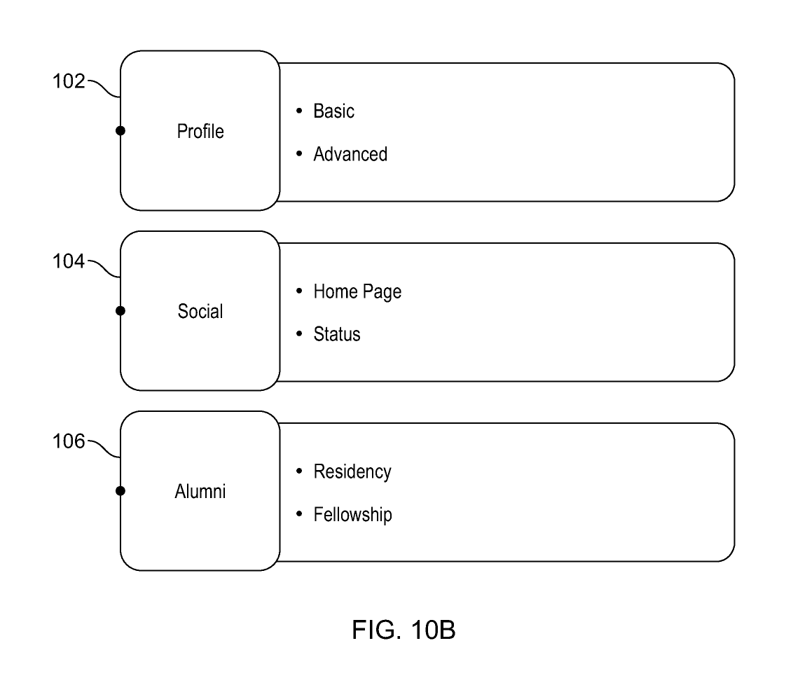

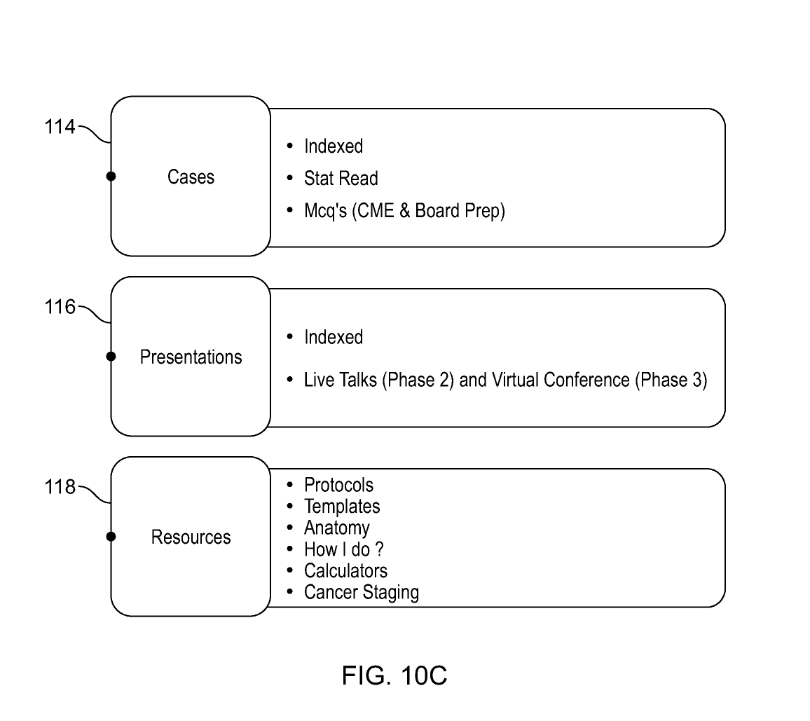

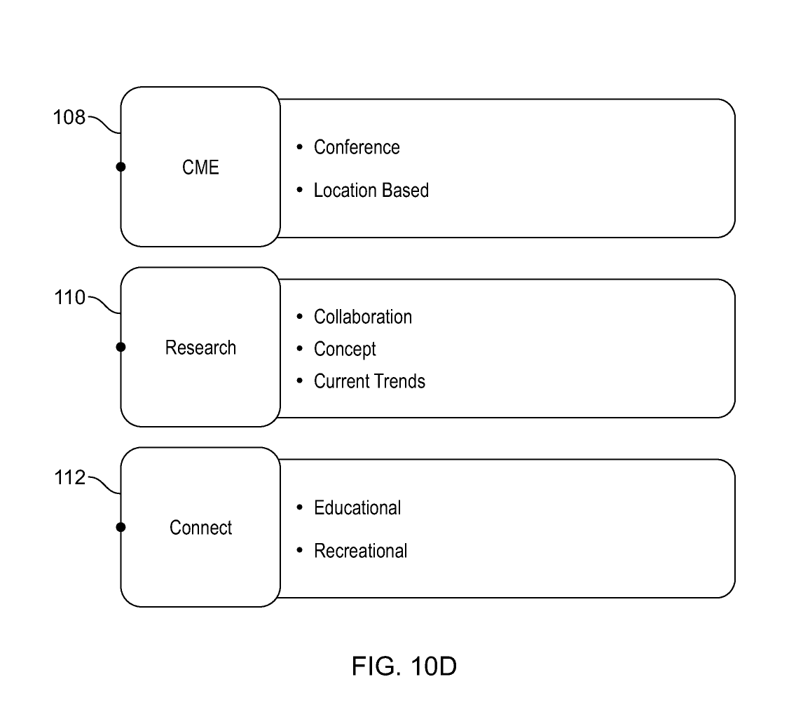

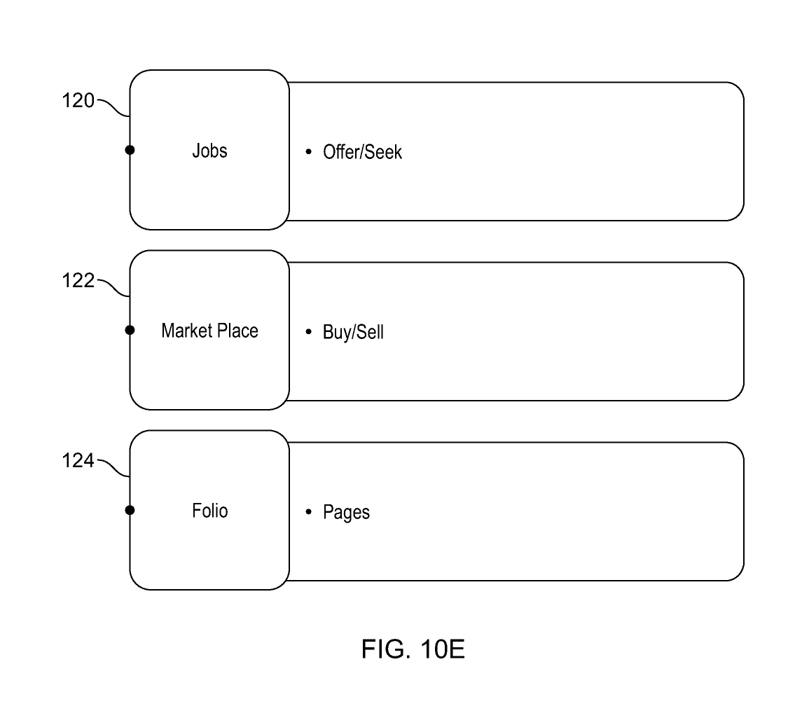

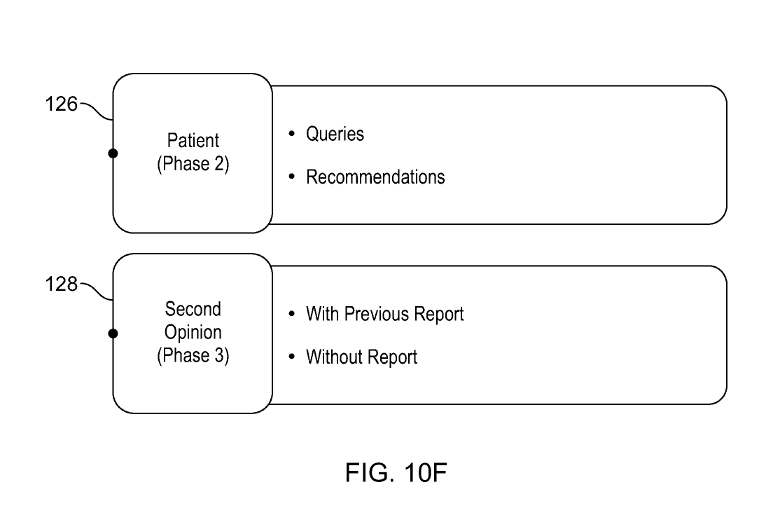

FIG. 10A shows an overview of the features of the exemplary embodiment of the platform of the present invention at 100. FIGS. 10B-10F show enlarged portions of FIG. 10A so that they features listed in FIG. 10A can be more easily read. These features will be described more fully below.

FIG. 1 shows a block diagram of a system for supporting the operations of the centralized professional platform 10. The operation of the platform 10 is described primarily with respect to how the user interacts with the content supported and stored on the server 12 through the website hosted on the server 12, though a user could interact with the content of the platform 10 stored on the server 12 through a smartphone application or another user interface. A server 12 is preferably a typical server 12 used for hosting web pages or for hosting other data that is accessible through a network connection. For example, the server 12 includes a transmitter/receiver 14 that is connected to a power supply 16, a processor 18, and a memory component 20. The server 12 is connected to a network, such as the Internet 22. The platform 10 is useful for supporting the content that is uploaded through a user interface such as a website or a smartphone application. This content is stored in the memory component 20. Users can access the centralized professional website that is hosted on the server 12. FIG. 1 shows four users of a centralized professional website in the field of medicine as an example, including two physicians 24 and two patients 26. Each physician 24 and patient 26 connects to the centralized professional website through a device 28, 30, such as a computer, a tablet computer, a laptop, a smartphone, or another electronic device. Each user accesses a webpage or another interface through this connection. Information can be transmitted to and from each user's device and to and from the server that hosts the centralized professional website. In the context of the exemplary embodiment for healthcare, the term “user” may be used interchangeably with the terms “patient” and “physician”.

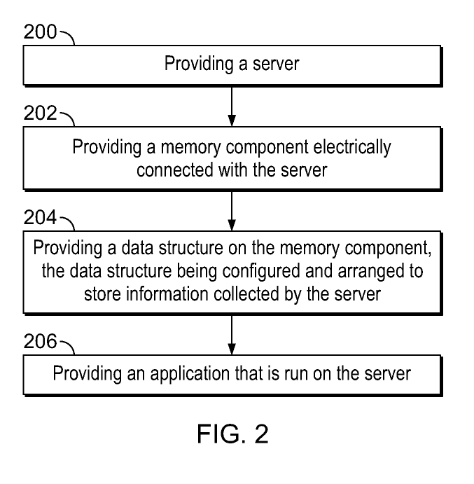

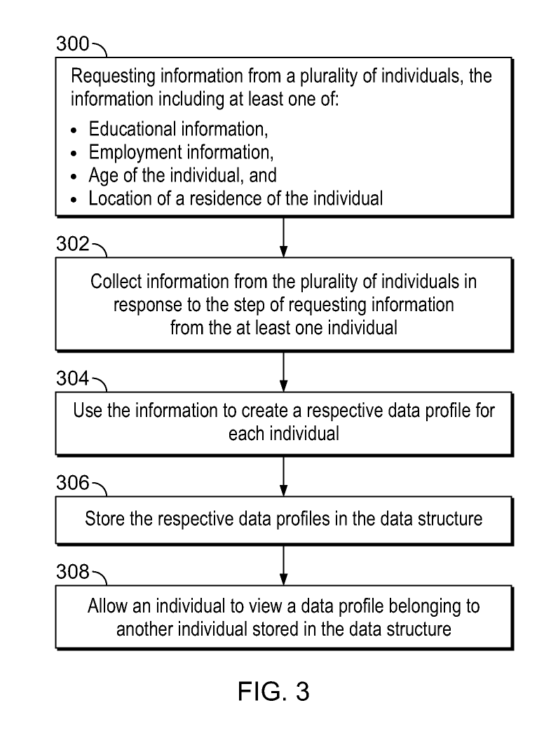

As shown in FIG. 2, and with reference to the structure of FIG. 1, the method of the present invention provides a server 12 at step 200, provides a memory component 20 electrically connected with the server 12 at step 202, and provides a data structure on the memory component 20 at step 204. The data structure is configured and arranged to store information collected by the server 12. The method also provides an application that is run on the server 12 at step 206. The application can include code stored in the memory component 20 of the server 12 that is run on the processor 16 of the server 12. As shown in FIG. 3, the application is operative for autonomously performing the following steps: requesting information at step 300, collecting information at step 302, using the information to create data profiles (or portfolios) for individuals at step 304, storing data profiles in the data structure at step 306, and allowing individuals to view data profiles of other individuals at step 308. The information requested from each individual may be information such as educational information, employment information, age of the individual, and location of a residence of the individual. The step 302 of collecting information from the individuals in response to the step 300 of requesting information from the individuals, but otherwise the steps may occur out of the sequence illustrated and repetitively.

The application may also be operative for prompting individuals to identify interests such as educational interests, recreational interests, and research interests. The application then stores these interests in the respective data profiles of the individuals. The application can also prompt a user of the centralized professional website to select a geographic region in which they are interested in visiting or in which they reside, and can then prompt the user to identify an interest related to education, recreation, and/or research. The application then notifies the user of other users of the centralized professional website who are within the selected geographic region and who share the same interest or interests as identified by the user. This allows users to conveniently and quickly locate other users who share the same educational, recreational, and/or research interests.

The centralized professional website is also useful for advertising upcoming events. The application can also prompt a user to input an advertisement for an upcoming event, such as an educational event, a recreational event, or a research opportunity. The application then notifies other individual users of the website about the advertisement. This is useful for helping individuals locate other professionals who share the same recreational interests, such as tennis partners or bridge partners. This is also useful for coordinating research. For example, one research group may be performing animal testing on one organ or system in a set of laboratory animals. Another research group may be looking for a set of laboratory animals for testing on another organ or system. For example, a first research group could advertise that they are testing a bone screw a limb for a set of animals. A second research group, interested in testing medical imaging equipment could be notified through the centralized professional website that this set of animals is available for such testing. Thus, the centralized professional website encourages efficient use of resources within the professional field.

Users can upload documents to share with other professionals. The application prompts an individual to upload at least one document, and then the application stores the uploaded document in the data structure. The stored documents are associated with the respective data profile of the individual. These documents can be selectively shared with or hidden from other individuals who have access to the centralized professional website.

The centralized professional website is useful for importing documents from other websites or other databases. For example, the application can import one or more publications from a publication database or a publication website, such as PubMed. The application stores each publication in the data structure, and associates the publication with the respective data profile or profiles of the individual or individuals listed as authors of the publication.

The application can also be configured to store information related to the publication, such as author information and title information, rather than the publication itself and/or in addition to the publication itself. The application is useful for autonomously requesting publication information related to a publication of an individual from another website or database. The application can then receive information related to the publication. This can be done either by an individual typing the information into an interface such as a form supported on the website, or it can be automatically imported from another website or database that hosts publications or publication information. The application aggregates publication information into a bibliography for the respective individual, and stores it in the data structure. This bibliography can be selectively made public by the respective individual. This bibliography can be selectively transmitted to other individuals or institutions.

The centralized professional website provides a simple one-click process for submitting certification requests and recertification requests to licensing bodies or certification bodies, such as state medical licensing agencies, federal licensing agencies, private licensing agencies, etc. The application aggregates licensing information from the data profile (or portfolio) of a respective individual, and transmits the licensing information to a licensing entity. The licensing data can include data regarding current certification status, documents required for certification, letters of recommendation from other professionals relating to the individual, personal information, contact information, home address, and other data.

The application is configured to prompt an individual to upload a professional license or certificate, or similar document. The application then stores information regarding this document, such as the expiration date, in the data profile of the respective individual. The application then calculates a due date for renewing the respective professional license or certificate or similar document. The application reminds the individual when the renewal is coming up soon. For example, the application can remind the individual that the renewal application is due in 90 days, 60 days, 30 days, and/or other periods of time. The application allows the individual to cause the server to transmit a renewal request for the professional license/certificate/etc. through a one-click procedure, because all of the information required by the licensing body is stored in the individual's portfolio.

The centralized professional website also supports letters of recommendation regarding other individuals who have profiles on the centralized professional website. These letters of recommendation can be from other individuals who have profiles on the centralized professional website, or from members of the general public. Letters of recommendation can be uploaded by an individual and then associated with that individual's profile on the website. The application can also prompt individuals to provide a letter of recommendation for another individual. This prompt can be randomly generated, or it can be a result of a request by an individual seeking a letter of recommendation from another professional who has a profile on the centralized professional website. After prompting an individual for a letter of recommendation, and after the individual uploads a letter of recommendation, the application stores each letter of recommendation in the respective data profile of the individual who is the subject of the letter of recommendation. The application allows individuals to selectively make public (or selectively share) the letters of recommendation that have been written about them, uploaded to the website, and associated with their profile.

The application also allows individuals to request a letter of recommendation from another individual and have the letter of recommendation sent directly to a third party, such as a prospective employer. Thus, there is no question that the individual requesting the letter viewed the content of the letter after it was sent by the individual signing the letter.

The centralized professional website is also useful for facilitating verification of a professional's educational background, employment history, or biographical data. The application is configured to prompt an individual to verify a set of employment information, educational information, or biographical information about another member of the website. For example, a first individual who claims to have graduated from a first university can be prompted to verify that they were classmates with a second individual who also claims to have graduated the same year from the same university. Verification information can then be stored in the data structure and associated with the second user's data profile. The verification information can be displayed on the individual's profile to show what information has been independently verified by other individuals.

The application is further useful for sharing data between users of the website. In the context of medical professionals, the centralized professional website includes an application that allows an individual (such as a patient or a medical professional) to upload a medical study to the data structure of the server. A medical study such as an imaging study typically contains personal image information. The application receives the medical study, and removes the personal image information from the medical study to create a redacted medical study. In the context of medical imaging studies (such as a CT scan) containing HIPAA-protected information, the application removes this HIPAA-protected information from the medical imaging study to create a redacted medical imaging study. The application stores the redacted medical study in the data structure.

Such a redacted imaging study can be shared with others who have access to the centralized professional website. Where the study was uploaded by a patient, the application prompts the patient to select medical professionals with whom to share the redacted medical study. The application then makes the redacted study available to the group of authorized individuals that is selected by the patient. The application then grants access to the redacted medical study to the members of the group when they request access to the study. The application facilitates discussion between members of the group by providing an interactive platform such as a private chat room in which the members of the group can discuss the study. This is useful when a patient is seeking a second read on an imaging study, or when a patient is seeking the help of a team of physicians. It should be noted that the discussion of sharing images refers to a patient, but the patient could be replaced by another individual such as a physician who has access to a medical study and is seeking feedback from other medical professionals. This can be particularly useful for a physician in a remote location or in a location where they do not frequently encounter a given medical condition. Such a physician could upload an image and seek assistance in interpreting the medical study from more experienced medical professionals.

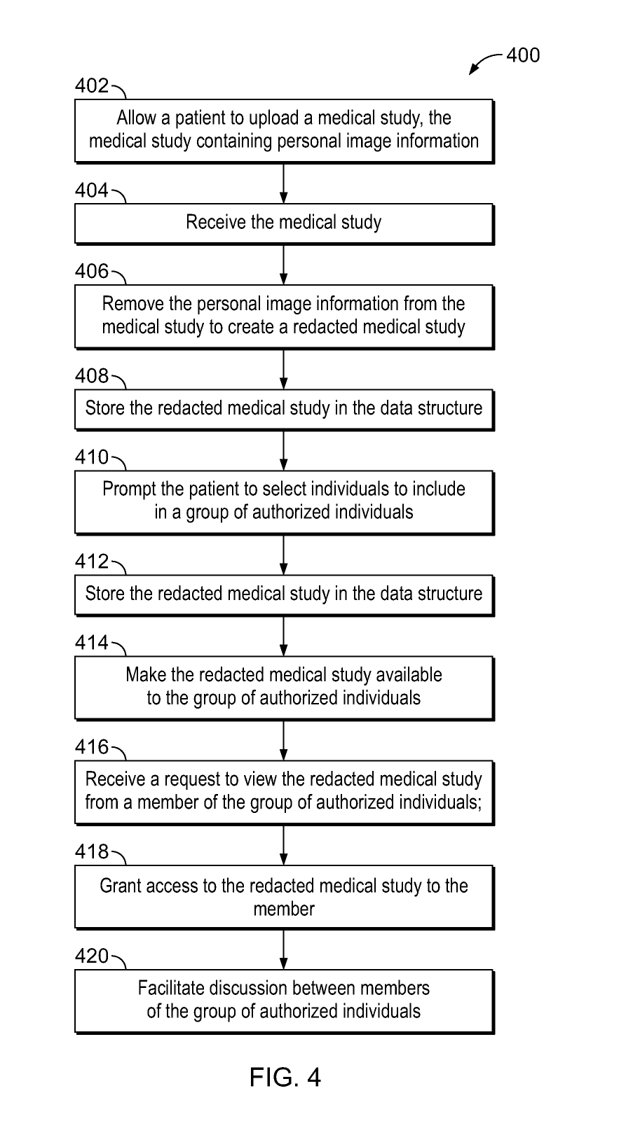

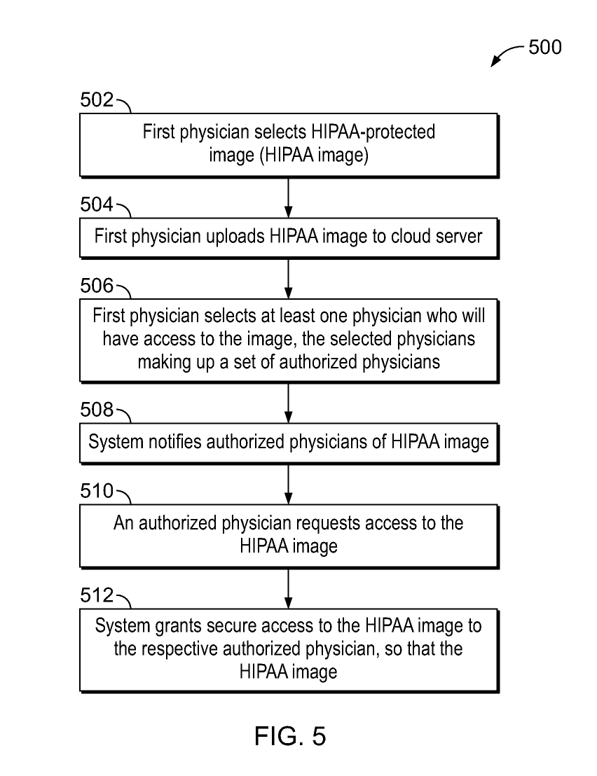

FIGS. 4 and 5 show flowcharts for sharing documents such as medical studies on the centralized professional website.

The application of the centralized professional website supports 10 receiving documents of various kinds, such as text documents, photographs, DICOM (Digital Imaging and Communications in Medicine) files, and other documents, and sharing them among selected users or all users of the website. The application is configured to receive a document that is uploaded by an individual. The application then allows the user to identify a second user, or a group of users, to share the document with. The application prompts the second user (or users) to review the document and to provide feedback to the first user. The application receives this feedback, and then transmits it to the first user.

By sharing documents such as medical studies, medical educational materials, professional society presentations (whether in text, audio, or video format), and other documents among professionals, the individuals can improve their professional skills. In the context of medical professionals, the centralized professional website can be used to facilitate improvement of patient care protocols, and to facilitate medical education.

Medical educational materials can include, for example, sample images of CT scans of breast cancer at various stages. Such images would include images from representative cases of patients where the findings were consistent with breast cancer at stages 0-IV. Such a set of images would include at least one patient image that is consistent with a finding of stage 0, at least one patient image that is consistent with a finding of stage I breast cancer, at least one patient image that is consistent with a finding of stage II breast cancer, at least one patient image that is consistent with stage III breast cancer, and at least one patient image that is consistent with stage IV breast cancer. Such educational materials would be available to a user through the centralized professional website, and would preferably be available for viewing simultaneously with images of a patient that a user is currently examining for possible breast cancer, or for breast cancer staging. This allows a user to read the patient's images and compare them side-by-side with images that are representative of the various stages of cancer. Such medical educational materials are useful for other cancers, and other medical conditions.

As shown in FIG. 4, the system 10 includes a method to allow a patient to upload a medical study, which will be redacted and distributed for study and comment, generally at 400. At step 402, the method allows a patient to upload a medical study, the medical study containing personal image information to the system 10. At step 404, the system 10 receives the medical study. At step 406, the system 10, removes the personal image information from the medical study to create a redacted medical study. At step 408, the system 10 stores the redacted medical study in the data structure. At step 410, the system 10 prompts the patient to select individuals to include in a group of authorized individuals. At step 412, the system 10 stores the group of authorized individuals with the redacted medical study in the data structure. At step 414, the system 10, makes the redacted medical study available to the group of authorized individuals, At step 416, the system 10 receives a request to view the redacted medical study from a member of the group of authorized individuals. At step 418, the system 10 grants access to the redacted medical study to the member. At step 420, the system 10 facilitates discussion between members of the group of authorized individuals.

As shown in FIG. 5, the system 10 includes a method to allow authorized distribution of protected HIPAA images, generally at 500. At step 502, the first physician selects a HIPAA-protected image. At step 504, the first physician uploads the HIPAA image to the server 10. At step 506, the first physician selects at least one physician who will have access to the image, where the selected physicians make up a set of authorized physicians. At step 508, the system 10, notifies authorized physicians of the HIPAA image. At step 510, an authorized physician requests access to the HIPAA images. At step 512, the system 10 grants secure access to the HIPAA image to the authorized physician for viewing.

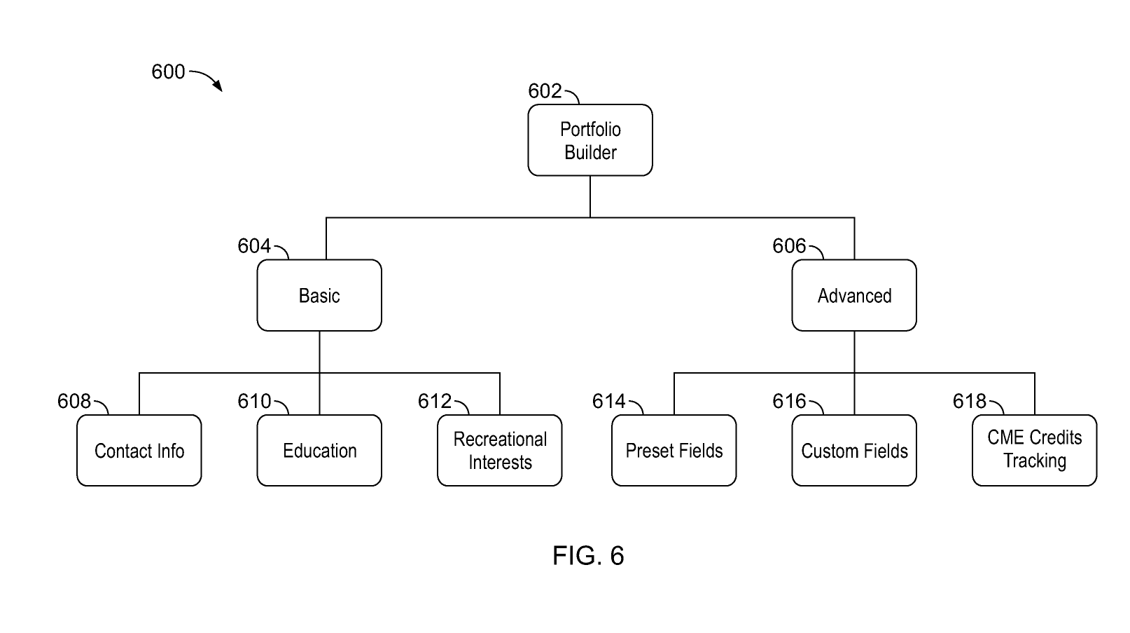

FIG. 6 shows the general block diagram of an individual profile hosted on the website at 600. The profile 600 is supported by a portfolio builder module 602 that includes basic 604 and advanced 606 components. The basic components 604 include contact information 608, educational information 610, and recreational interests 612 of an individual. The advanced components 606 allow the individual to incorporate additional features into his or her profile 600, such as preset fields 614, custom fields 616, and continuing medical education (CME) credits tracking 618.

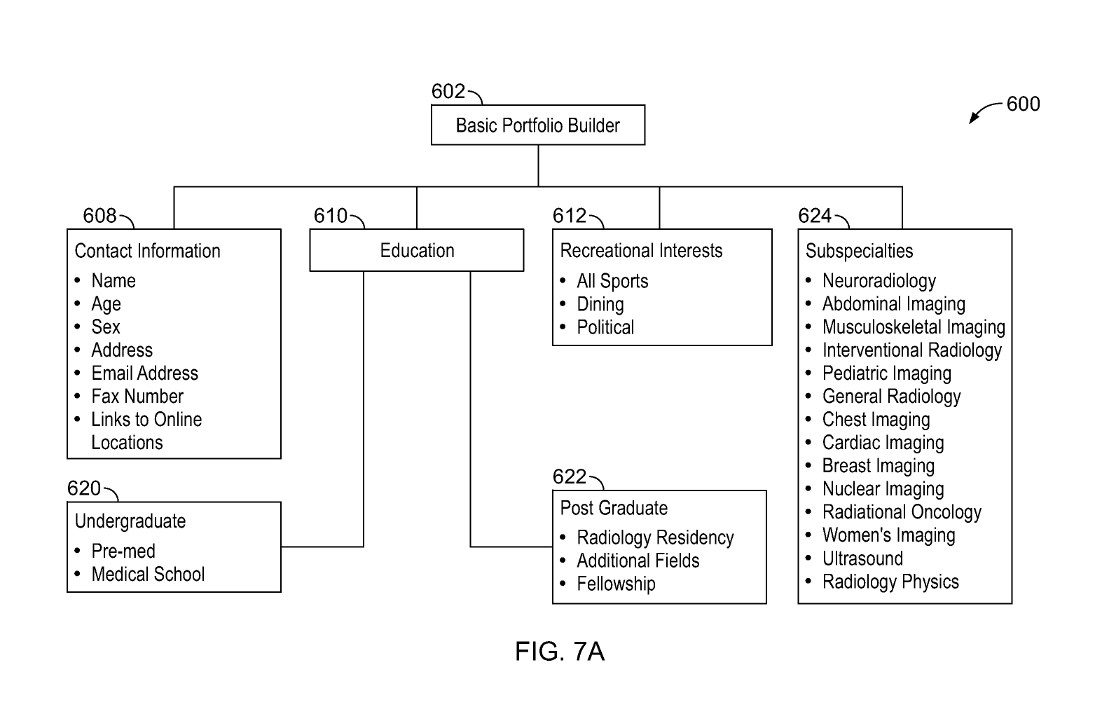

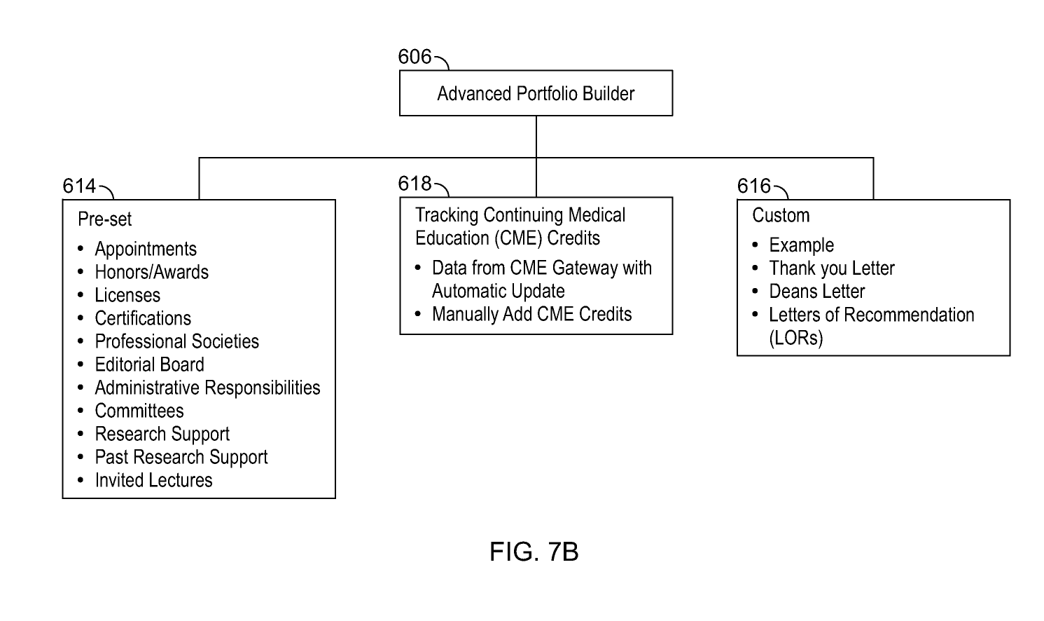

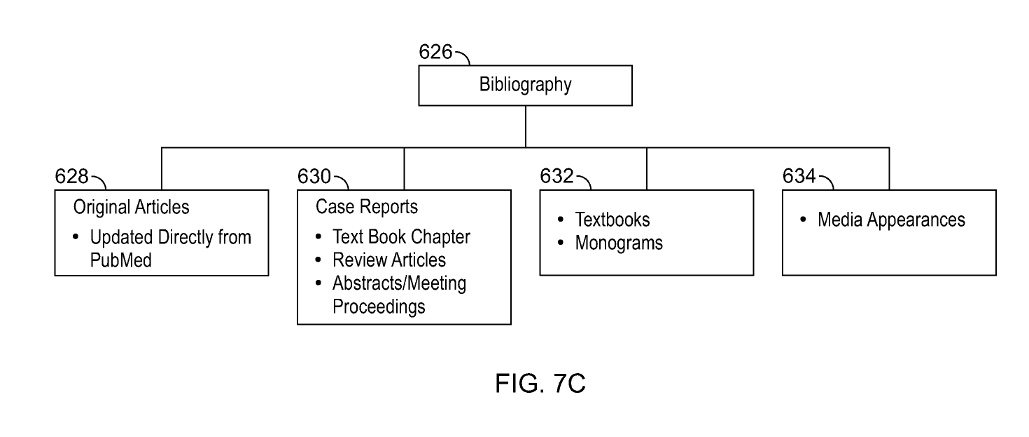

FIGS. 7A-C shows a more detailed block diagrams of components 604, 606 of an individual profile hosted on the server 10, including components for undergraduate education 620, post graduate education 622 and medical subspecialties 624. Further, as shown in FIG. 7C, a blibliography component 626 may be provided to include data about an individual's publications and appearances, such as original articles 628, case reports 630, books 632, and media appearances 634

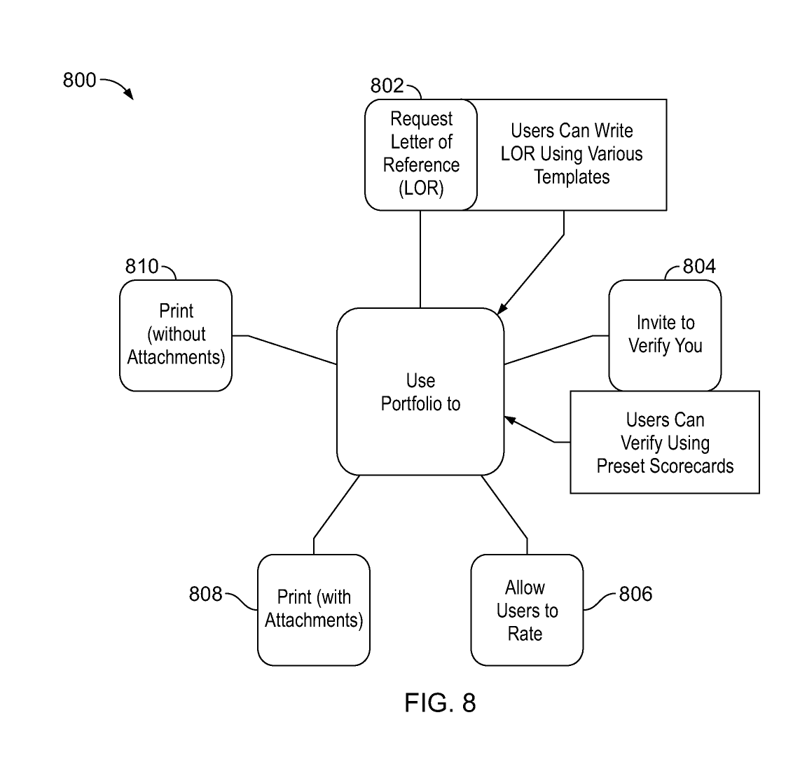

FIG. 8 shows various actions a user can take, generally at 800. An individual can use the application to request a letter of recommendation or a letter of reference (LOR) 802 from another individual member of the website. This can be done by providing a template to the person from whom the LOR is being requested. Individuals can be invited to verify information that is on another individual's profile, either autonomously or in response to a user request at action 804. This can be done using preset scorecards. The portfolio allows other users to rate another individual, such as by providing an overall rating, or by rating various aspects of their professional interaction with the other person or by rating the other individual's professional achievements at action 806. The website supports providing the portfolio and the attachments (such as bibliography, licensing documents, etc.) in a conveniently printable format. This is particularly useful for licensing agencies when an individual requires a license renewal, as discussed above. The licensing agency can simply request all relevant documents and have them conveniently printed or otherwise transmitted to the licensing agency in another appropriate format, such as a portable document format (PDF) at action 808. Alternatively, a portfolio can be printed without attachments at action 810.

By allowing individuals to rate the professional performance of other individuals, and to rate other aspects of other individuals' behavior or experience, the centralized professional website encourages positive behavior among individuals. The rating system can be on a number scale such as a 1-10 scale, but is preferably measured on a visual scale such as a scale that uses smiley faces that is similar to the scale medical professionals use to assess pain experienced by a patient. A positive review of another individual would correspond to a happy face. A negative review of another individual would correspond to a sad or upset face. The reviews are not anonymous, but are linked to the reviewer's portfolio.

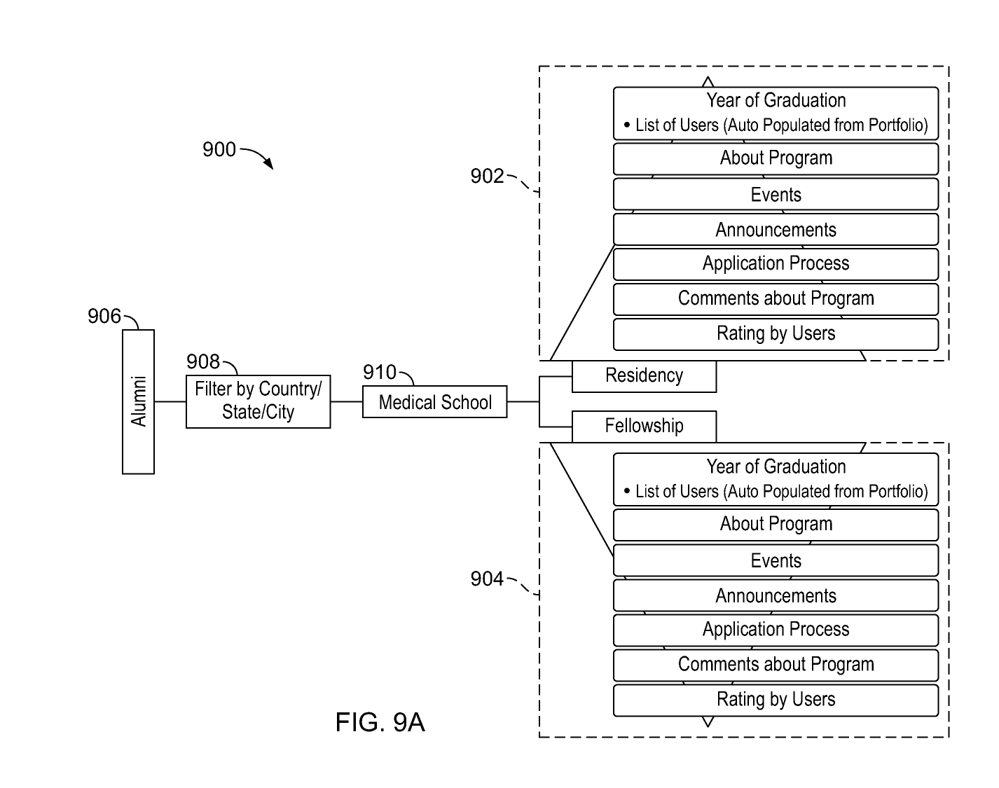

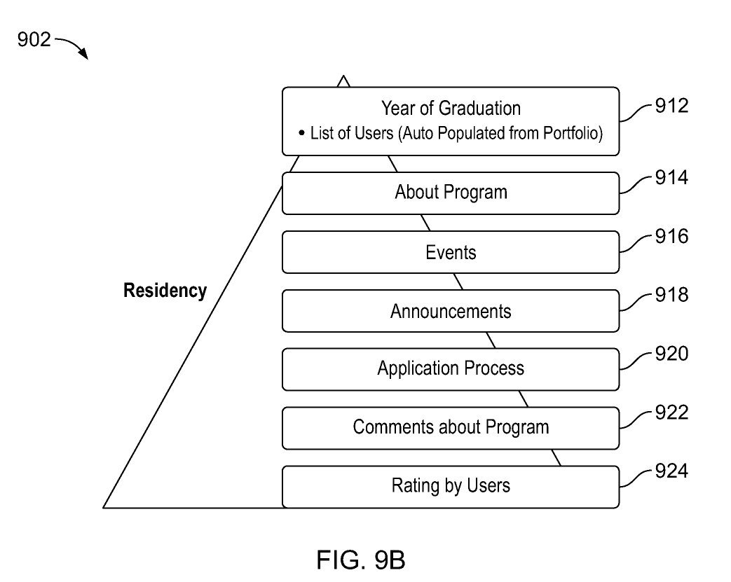

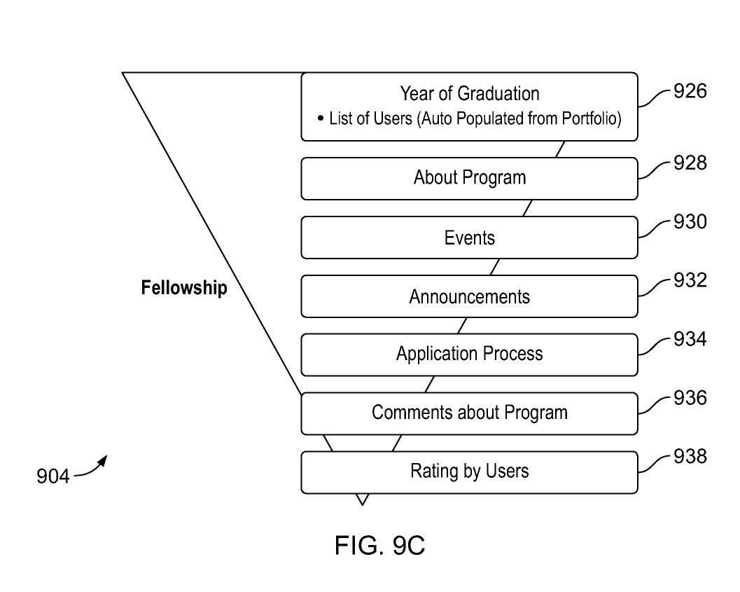

FIG. 9A shows a sample block diagram of an exemplary structure of alumni groups at 900. FIGS. 9B and 9C show enlarged portions of FIG. 9A, showing sample pages or categories of information provided on the pages associated with a respective medical residency program at a medical institution 902 or a respective medical fellowship program 904. Alumni groups 906 are automatically populated by the application based on the educational information included in individual's portfolios. Alumni groups 906 can be sorted by country/state/city/other geographic region 908, medical school 910, and then further broken down into residency 902 and fellowship programs 904. A residency program 902 can include pages on their profile that list individuals by their year of graduation 912. This can be automatically populated by the application, which can sort through the data profiles of all individuals and extract names of individuals matching the institution and year of graduation. The residency program 902 can also include pages that provide information about 914 the residency program, list events 916 or announcements 918, describe the application process 920, host comments about the program 922, and show a rating by individuals 924.

Similarly, medical fellowship programs 904 can have their own respective profiles with similar information. A medical fellowship program 904 can include pages on their profile that list individuals by their year of graduation 926. This can be automatically populated by the application, which can sort through the data profiles of all individuals and extract names of individuals matching the institution and year of graduation. The medical fellowship program 904 can also include pages that provide information about 928 the medical fellowship program, list events 930 or announcements 932, describe the application process 934, host comments about the program 936, and show a rating by individuals 938.

Medical product manufacturers can similarly have their own pages, and/or they can have profiles that are specific to their products. This allows individuals to rate the given product or manufacturer. When an individual is seeking to purchase new medical equipment, they can review profiles of the relevant manufacturers and products to more quickly determine whether they should purchase the given products. Profiles of the manufacturers and products include a rating feature similar to the individual rating described above.

The application also allows individuals to register for professional events, such as professional society conferences.

Users can search individual portfolios on the website by name, employer, educational institution currently or previously attended, location of residence, gender, age, employment position, occupation, and other categories of information stored in the individual portfolios.

Referring to FIG. 10A, an overview of the features of the exemplary embodiment of the platform of the present invention is shown generally at 100. The platform includes a number of modules to facilitate user interaction, including a profile module 102, social module 104, alumni module 106, CME module 108, Research module 110, a Connect module 112, a Cases module 114, a presentations module 116, a resources module 118, a jobs module 120, a marketplace module 122, a folio module 124, a patient module 126 and a second opinion module 128.

Referring to FIG. 10B, the profile module is programmed to provide basic and advanced profile management functions describe in FIG. 6 above. The social module 104 is programmed to provide a home page for the user and status information about the user. The alumni module 106 is programmed to provide information on residency and fellowship programs as described above with FIGS. 9A-C.

Referring to FIG. 10C, the cases module 112 is programmed to provide an index of cases of the user, the status of whether the case has been read and MCQ's (for CME and medical board prep). The presentations module 116 is programmed to provide and facilitate live talks and virtual conference between users, physicians and patients of the system. The live talks and virtual conferences may be indexed. The resources module 118 is programmed to provide miscellaneous information concerning protocols, user templates, anatomy, how to's, calculators of various sorts (such as BMI, for instance), and cancer staging.

Referring to FIG. 10D, the CME module 108 is programmed to provide conferences that a physician may attend to obtain CME credit. The list of conferences may be location based. The research module 110 is programmed to facilitate collaboration between physicians, provide news of current trends and concepts users may be interested in following. The connect module 112 is programmed to facilitate educational and recreational connections between users of the system.

Referring to FIG. 10E, the job module 120 is programmed to provide and facilitate matches between job seekers and employers. The marketplace module 122 is programmed to facilitate public and private sales of items and services. The folio module 124 is programmed to provide pages a user desire to clip and retain.

Referring to FIG. 10E, the patient module 126 is programmed to receive patient queries and physician recommendations for the patient. The second opinion module 128 is programmed to obtain a second opinion from another physician and may include or not include the previous recommendation.

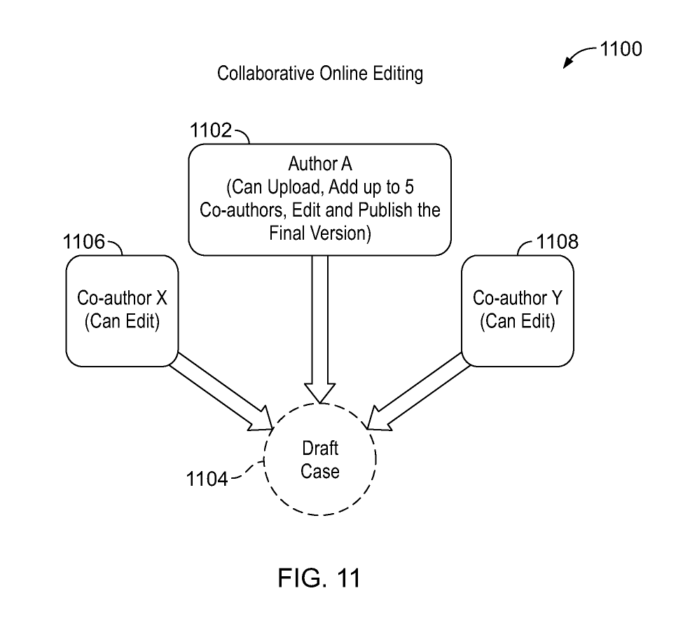

Referring to FIG. 11, the platform provides collaborative online edit feature for authors and all the co-authors of a case where the content including medical images can be edited illustrated generally at 100. For example, author A 1102 uploads a case as a draft case 1104 under his login profile and lists co-authors X 1106 and Y 1108 for the case. Then the co-authors X and Y 1106, 1108 will get notification and the case will be listed as a draft case 1104 under co-authors login X and Y 1106, 1108. Co-authors X and Y can make changes to the case online and author A 1102 will submit the finalized case for publication. During this collaborative editing by contributors 1102, 1106, 1108 of a case 1104 the application allows only one author 1102 or co-author 1106, 1108 to edit at a time and locks the access to others. The last edit date and time by a contributor 1102, 1106, 1108 on a case will be displayed to all the contributors 1102, 1106, 1108.

Although the above discussion has been in relation to the medical field, the centralized professional website is useful for other fields.

Although the above discussion has been generally in the context of individuals who access the website on their own behalf, and who have their own data profile on the website, the centralized professional website is useful for non-human entities. For example, a corporation or another employer, an education institution, a licensing body, an alumni group of an educational institution, a recreational group, etc. can each have their own profile hosted by the centralized professional website. This allows the individuals to interact with these groups or entities through the website.

Generally, the platform of the present invention is accessible on a general purpose computer through a website that is hosted by the server or through code stored in a memory component of the computer and operable by the processor of the computer. The platform of the present invention can also be or alternatively be accessible through another electronic device (such as a cell phone, a tablet computer, or another electronic device) through a software application stored in a memory component on that electronic device or through a website that is hosted by the server. The electronic device is capable of interacting with the server through a network connection.

It can therefore be seen that the present invention provides a method and a system that provide a single platform that allows an individual to maintain a professional online profile, interact with other individuals who share common interests, review professional certification requirements, renew professional certifications, share details regarding upcoming events, share documents, collaborate with other professionals, rate other professionals, and rate products used by professionals in the professional field; provides a centralized professional website that allows users to share HIPAA-protected medical images in a HIPAA-compliant manner; provides a centralized professional website that facilitates interaction between professionals in a geographic region; provides a centralized professional website that facilitates interaction between graduates of a given educational institution; the provision of a centralized professional website that facilitates sharing of medical images between professionals for a second opinion; and provides a centralized professional website that facilitates sharing of medical images between patients and physicians. For these reasons, the instant invention is believed to represent a significant advancement in the art which has substantial commercial merit.

While there is shown and described herein certain specific structure and methods embodying the invention, it will be manifest to those skilled in the art that various modifications and rearrangements of the parts and steps may be made without departing from the spirit and scope of the underlying inventive concept and that the same is not limited to the particular forms herein shown and described except insofar as indicated by the scope of the appended claims.

What is claimed is:

1. A computer assisted method comprising:
providing a server;
providing a memory component electrically connected with the server;
providing a data structure on the memory component, the data structure being configured and arranged to store information collected by the server;
providing an application that is run on the server, the application being operative for autonomously performing the following steps:
requesting information from a plurality of individuals, the information comprising at least one of: educational information, employment information, age of the individual, and location of a residence of the individual;
collecting information from the plurality of individuals in response to the step of requesting information from the at least one individual;
using the information to create a respective data profile for each individual;
storing the respective data profiles in the data structure;
allowing an individual to view a data profile belonging to another individual stored in the data structure.

2. The method of claim 1, the application further comprising the steps of:
prompting the plurality of individuals to identify an interest selected from at least one of: an educational interest, a recreational interest, and a research interest;
storing the respective interests in the respective data profiles;
prompting a user to select a geographic region;
prompting the user to identify an interest selected from at least one of: an educational interest, a recreational interest, and a research interest;
notifying the individual of other users who are located within a selected geographical region and who have also identified the interest.

3. The method of claim 1, the application further comprising the steps of:
prompting a user to input an advertisement regarding at least one of: an educational event, a recreational event, and a research opportunity; and
notifying at least one individual about the advertisement.

4. The method of claim 1, the application further comprising the steps of:
prompting an individual to upload at least one document;
storing the at least one document in the data structure;
associating the at least one document with the respective data profile of the respective individual; and
allowing the respective individual to selectively share the document with other individuals.

5. The method of claim 1, the application further comprising the steps of:
importing a publication from a database;
storing the publication in the data structure;
associating the publication with a respective data profile of a respective individual.

6. The method of claim 1, the application further comprising the steps of:
requesting publication information related to a publication of an individual;
receiving publication information related to the publication;
aggregating publication information into a bibliography of the respective individual stored on in the data structure;
making the bibliography available to other individuals.

7. The method of claim 1, the application further comprising the steps of:
aggregating licensing information from the data profile of a respective individual;
transmitting the licensing information to a licensing entity.

8. The method of claim 7, the application further comprising the steps of:
prompting an individual to upload a professional license;
storing an expiration date related to the professional license in the data profile of the respective individual;
calculating a due date for renewing the professional license;
allowing the individual to cause the server to transmit a renewal request for the professional license through a one-click procedure.

9. The method of claim 1, the application further comprising the steps of:
prompting each individual to provide a letter of recommendation for another individual;
storing each letter of recommendation in the respective data profile of the other individual; and
allowing the other individual to selectively share the respective letter of recommendation.

10. The method of claim 1, the application further comprising the steps of:
prompting an individual to verify a set of employment information related to another individual.

11. The method of claim 1, the application further comprising the steps of:
allowing a patient to upload a medical study, the medical study containing personal image information;
receiving the medical study;
removing the personal image information from the medical study to create a redacted medical study;
storing the redacted medical study in the data structure;
prompting the patient to select individuals to include in a group of authorized individuals;
making the redacted medical study available to the group of authorized individuals;
receiving a request to view the redacted medical study from a member of the group of authorized individuals;
granting access to the redacted medical study to the member; and
facilitating discussion between members of the group of authorized individuals.

12. The method of claim 1, the application further comprising the steps of:
receiving a document uploaded by a user
allowing the user to identify a second user to share the document with prompting the second user to review the document and to provide feedback;
receiving the feedback;
transmitting the feedback to the first user.

13. A system for centralized professional platform for interaction between patients and physicians, comprising:
a website arrangement containing at least one profile having a medical study containing at least one medical image and personally identifying material; and
a computer server coupled to the website arrangement and programmed to (i) remove the personally identifying material from the medical study, creating a redacted medical study; (ii) storing the redacted medical study; (iii) authorizing a plurality of authorized individuals to access the redacted medical study; and (iv) facilitate discussion between the plurality of authorized individuals about the redacted medical study to form a first opinion of the redacted medical study;
wherein the computer server stores the first opinion.

14. The system of claim 13, wherein the computer server is further programmed to (v) authorizing a second plurality of authorized individuals to access the redacted medical study; and (vi) facilitate discussion between the second plurality authorized individuals about the redacted medical study to form a second opinion of the redacted medical study.

15. The system of claim 13, wherein the computer server is further programmed to (vii) transmit the first opinion of the redacted medical study to a patient.

16. The system of claim 14, wherein the computer server is further programmed to (viii) transmit the second opinion of the redacted medical study to a patient.

17. The system of claim 13, wherein:
The website arrangement contains a user profile having basic module and an advanced module, the basic module containing contact info, education credentials, and recreational interest, the advance module containing preset fields, custom fields and CME credits tracking; and
the computer server is further programmed to (ix) request information from a plurality of individuals, the information comprising at least one of: educational information, employment information, age of the individual, and location of a residence of the individual; (x) collect information from the plurality of individuals in response to the step of requesting information from the at least one individual; (xi) use the information to create a respective data profile for each individual; and (xiii) store the respective profiles;
wherein the computer server allows an individual to view a profile belonging to another individual stored in the computer server.

18. The system of claim 13, wherein the computer serve further programmed to (xiv) import a publication from a database; (xv) store the publication on the computer server; and (xvi) associate the publication with a user profile of a respective individual.

19. The system of claim 13, wherein the computer server is further programmed to (xvii) request publication information related to a publication of an individual; (xviii) receive publication information related to the publication; (xix) aggregate publication information into a bibliography of the respective individual stored on the computer server; and (xx) make the bibliography available to other individuals.

20. The system of claim 13, wherein the computer server is further programmed to (xxi) aggregate licensing information from the profile of a respective individual; and (xxii) transmit the licensing information to a licensing entity.
